(19) United States
(12) Patent Application Publication
(10) Pub. No.: US 2021/0408622 A1
(43) Pub. Date: Dec. 30, 2021

(54) BATTERY DEVICE

(71) Applicants: AISIN CORPORATION, Kariya-shi (JP); AISIN KEIKINZOKU KABUSHIKI KAISHA, Imizu-shi (JP)

(72) Inventors: Hiroshi OKAZAKI, Kariya-shi (JP); Takumi GONOJI, Toyama-shi (JP)

(73) Assignees: AISIN CORPORATION, Kariya-shi (JP); AISIN KEIKINZOKU KABUSHIKI KAISHA, Imizu-shi (JP)

(21) Appl. No.: 17/354,346

(22) Filed: Jun. 22, 2021

(30) Foreign Application Priority Data
Jun. 25, 2020 (JP) 2020-109536

(51) Int. Cl. H01M 10/6554; H01M 10/613; H01M 10/625; H01M 10/647; H01M 10/6556; H01M 50/209

(52) U.S. Cl. CPC H01M 10/6554; H01M 10/613; H01M 10/625; H01M 2220/20; H01M 10/6556; H01M 50/209; H01M 10/647

(57) ABSTRACT

A battery device includes a case and a plurality of batter cells. The case includes a base portion and a cover portion. The base portion includes: a base plate on which the battery cells are placed; a bottom wall portion provided on a side of the base plate, the side being opposite to a surface on which the battery cells are placed, such that the bottom wall portion is provided at a position distanced from the base plate, and a plurality of vertical wall portions having a band-plate shape, the vertical wall portions extending in a predetermined direction between the base plate and the bottom wall portion. The opposite ends of the vertical wall portions in a width direction are connected to the bottom wall portion and the base plate, respectively.

### CROSS-REFERENCE TO RELATED APPLICATION

This application claims priority to Japanese Patent Application No. 2020-109536 filed on Jun. 25, 2020, incorporated herein by reference in its entirety.

### BACKGROUND

### 1. Technical Field

The present disclosure relates to a battery device.

### 2. Description of Related Art

For example, as described in Japanese Unexamined Patent Application Publication (Translation of PCT Application) No. 2019-525397 (JP 2019-525397 A), a battery device has been known. The battery device includes a plurality of base plates, a plurality of battery cells, and a heat exchanger. The base plates are generally plate-shaped members. The battery cells are attached to upper surfaces of the base plates, and the heat exchanger (a square pipe as a flow path for refrigerant (coolant)) is attached to lower surfaces (parts placed below the battery cells) of the base plates.

### SUMMARY

An outer surface of an upper wall portion of the square pipe abuts with the lower surfaces of the base plates. Heat of the battery cells is transmitted to refrigerant via the base plates and the wall portion of the square pipe. In this configuration, it is difficult to completely bring the base plates into close contact with the upper wall portion of the square pipe, so that a slight gap might be partially caused. In a case where such a gap is caused, heat exchange efficiency (temperature control performance) decreases. Further, improvement (prevention of a decrease) of the heat transfer efficiency between the base plates and the square pipe can be achieved by putting a sheet (an elastic body) having a relatively high heat conductivity between the base plates and the square pipe. However, in this case, a component cost is high, and a product size (a dimension in a thickness direction) as the whole battery device is large.

The present disclosure provides a battery device including a heat exchanger and reduced in thickness.

A battery device according to an aspect of the present disclosure includes a case and a plurality of battery cells stored in the case. The case includes a base portion on which the battery cells are placed, and a cover portion configured to cover the battery cells placed on the base portion. The base portion includes: a base plate on which the battery cells are placed; a bottom wall portion provided on a side of the base plate, the side being opposite to a surface on which the battery cells are placed, such that the bottom wall portion is provided at a position distanced from the base plate; and a plurality of vertical wall portions having a band-plate shape, the vertical wall portions extending in a predetermined direction between the base plate and the bottom wall portion. The opposite ends of the vertical wall portions in the width direction of the vertical wall portions are connected to the bottom wall portion and the base plate, respectively.

In the base portion of the battery device according to the aspect of the present disclosure, the battery cells are placed on a first surface (hereinafter referred to as an upper surface) of the base plate. In the meantime, the bottom wall portion is placed at a position distanced from a second surface (hereinafter referred to as a lower surface) of the base plate, and a space between the bottom wall portion and the lower surface of the base plate is sectioned by the vertical wall portions into a plurality of spaces. Refrigerant can be circulated through these spaces. In this configuration, a part corresponding to the upper wall portion in the battery device in the related art is not provided. Accordingly, heat from the battery cells is directly transmitted to the refrigerant via the base plate. Accordingly, the present disclosure does not cause a problem caused due to close contactness between the base plate and the upper wall portion of the square pipe in the battery device in the related art or a problem caused when a sheet is used. That is, the battery device of the present disclosure is reduced in thickness in comparison with the battery device in the related art.

In the above aspect, an end part of each of the vertical wall portions, the end part being on a side closer to the base plate, may have a wall thickness larger than wall thicknesses of other parts of the each of the vertical wall portions.

In this configuration, since a contact area between the vertical wall portion and the base plate is large, it is possible to improve a joining strength between the vertical wall portion and the base plate.

In the above aspect, recesses and projections may be provided on an inner peripheral surface of a tubular portion defined by the base plate, the bottom wall portion, and the vertical wall portions.

In this configuration, a surface area (an area that makes contact with the refrigerant) of an inner peripheral surface of the tubular portion can be set to be large in comparison with a case where the inner peripheral surface of the tubular portion is planar. Accordingly, it is possible to improve heat exchange efficiency.

In the above aspect, a tubular portion defined by the base plate, the bottom wall portion, and the vertical wall portions may be configured such that a sectional area of a first end side of the tubular portion in an extending direction of the tubular portion is larger than a sectional area of a second end side of the tubular portion.

In the above configuration, when the refrigerant is circulated from the first end side of the tubular portion to the second end side, a flow rate of the refrigerant is higher on the downstream side than on the upstream side. That is, the flow rate of the refrigerant can be set to be high below the battery cells. This can improve the heat exchange efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery device according to the present disclosure;

FIG. 2A is a perspective view illustrating an upper surface, a right surface, and a front surface of the battery device illustrated in FIG. 1 in a state where a cover portion of the battery device is removed;

FIG. 2B is a perspective view illustrating a lower surface, the right surface, and the front surface of the battery device illustrated in FIG. 1 in a state where the cover portion of the battery device is removed;

FIG. 3 is an exploded perspective view of the battery device (a part other than the cover portion);

FIG. 4 is an enlarged perspective view of a second channel;

FIG. 5 is an enlarged view of a right end (a left end) of the second channel;

FIG. 6 is a sectional view perpendicular to a front-rear direction of the battery device;

FIG. 7 is a sectional view perpendicular to a right-left direction of the battery device (an enlarged view of one battery module and its peripheral part);

FIG. 8 is a plan view illustrating an outline of a path for refrigerant;

FIG. 9 is a sectional view perpendicular to a right-left direction of a second channel according to a first modification of the present disclosure;

FIG. 10 is a sectional view perpendicular to a front-rear direction of a second channel according to a second modification of the present disclosure;

FIG. 11 is a sectional view perpendicular to a front-rear direction of a second channel according to a third modification of the present disclosure;

FIG. 12 is a sectional view perpendicular to a right-left direction of a second channel according to a fourth modification of the present disclosure;

FIG. 13 is a sectional view perpendicular to a front-rear direction of a battery device according to a fifth modification of the present disclosure;

FIG. 14 is a plan view illustrating an outline of a path for refrigerant in a battery device according to a sixth modification of the present disclosure; and

FIG. 15 is a plan view illustrating an outline of a path for refrigerant in a battery device according to a seventh modification of the present disclosure.

### DETAILED DESCRIPTION OF EMBODIMENTS

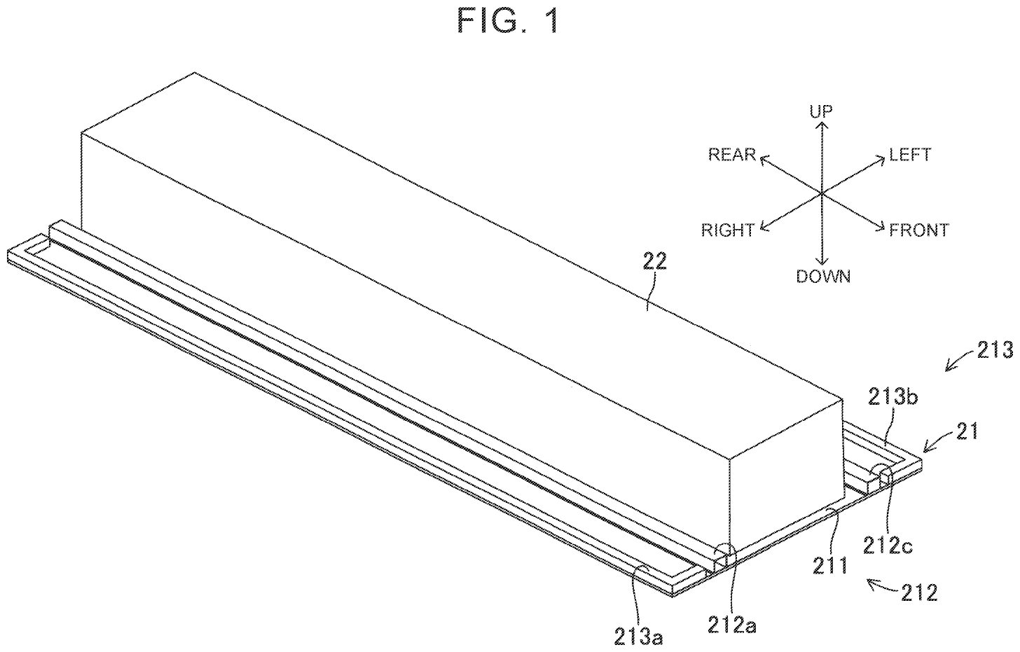

The following describes a battery device 1 according to one embodiment of the present disclosure (see FIG. 1). The battery device 1 is placed under a floor of a vehicle (an electric vehicle), for example, and electric power to be supplied to an electric motor is stored in the battery device 1. As illustrated in the figure, the battery device 1 has a generally rectangular solid shape. An extending direction of the shortest side among three sides of the rectangular solid shape is referred to as an up-down direction. An extending direction of a long side out of the other two sides is referred to as a front-rear direction, and an extending direction of a short side out of the other two sides is referred to as a right-left direction. For example, the battery device 1 is placed under the floor of the vehicle such that the up-down direction, the front-rear direction, and the right-left direction of the battery device 1 correspond to the vehicle height direction, the vehicle front-rear direction, and the vehicle width direction, respectively.

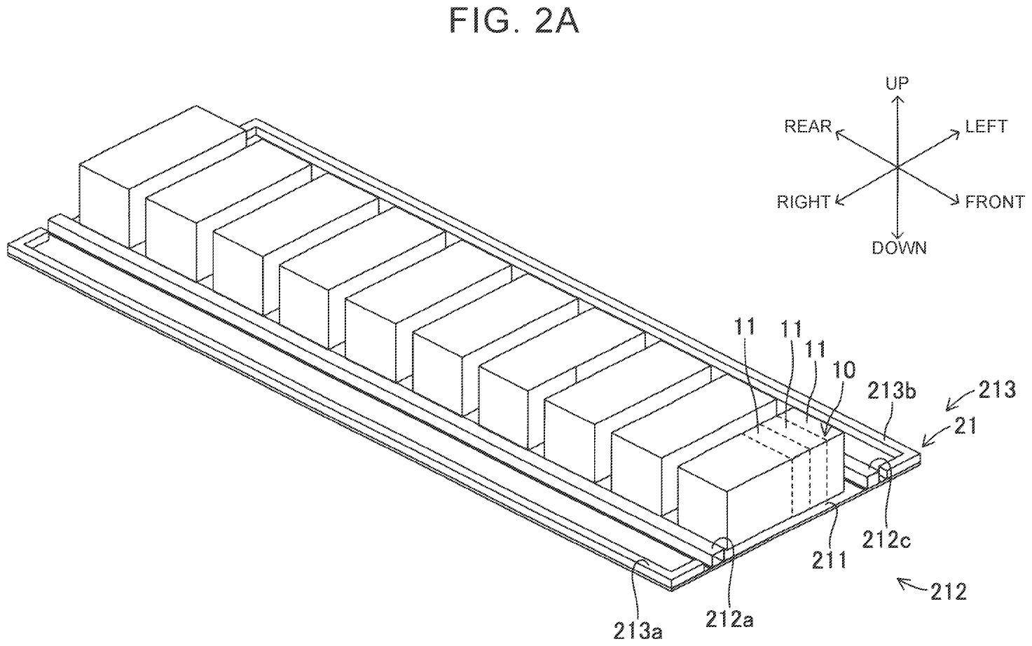

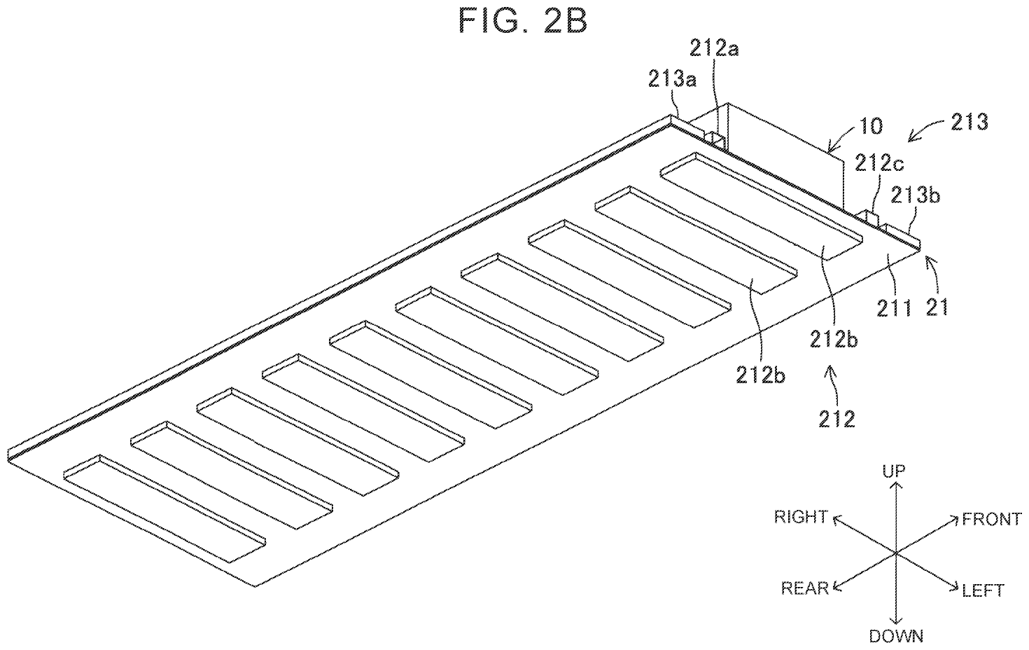

The battery device 1 includes a plurality of battery modules 10 and a case 20 (see FIG. 2A). Each of the battery modules 10 is configured such that a plurality of battery cells 11 is arranged to form one module. The battery modules 10 are stored in the case 20 (described below).

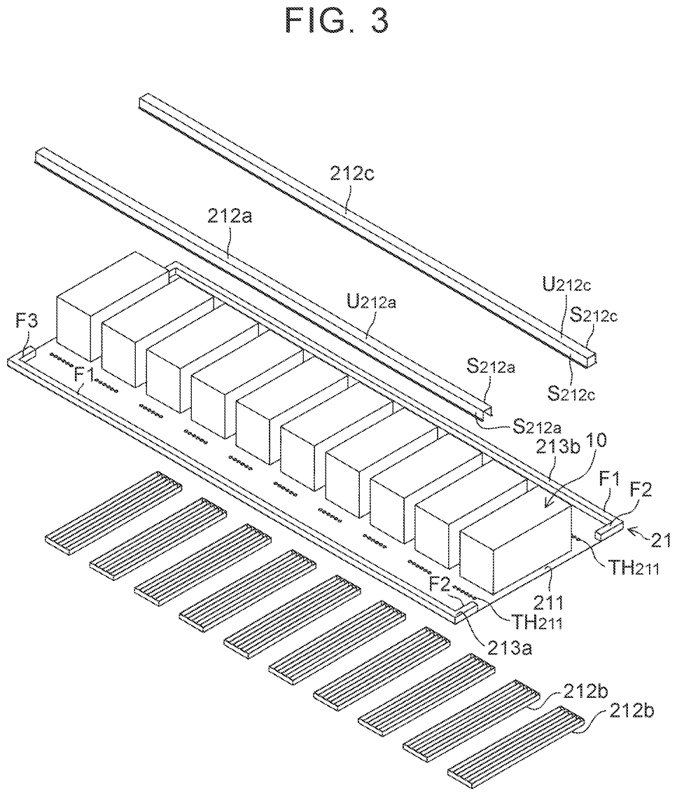

The case 20 includes a base portion 21 and a cover portion 22 (see FIG. 1). The base portion 21 includes a base plate 211, a heat exchanger 212, and a frame 213 (see FIGS. 2A, 2B, and 3).

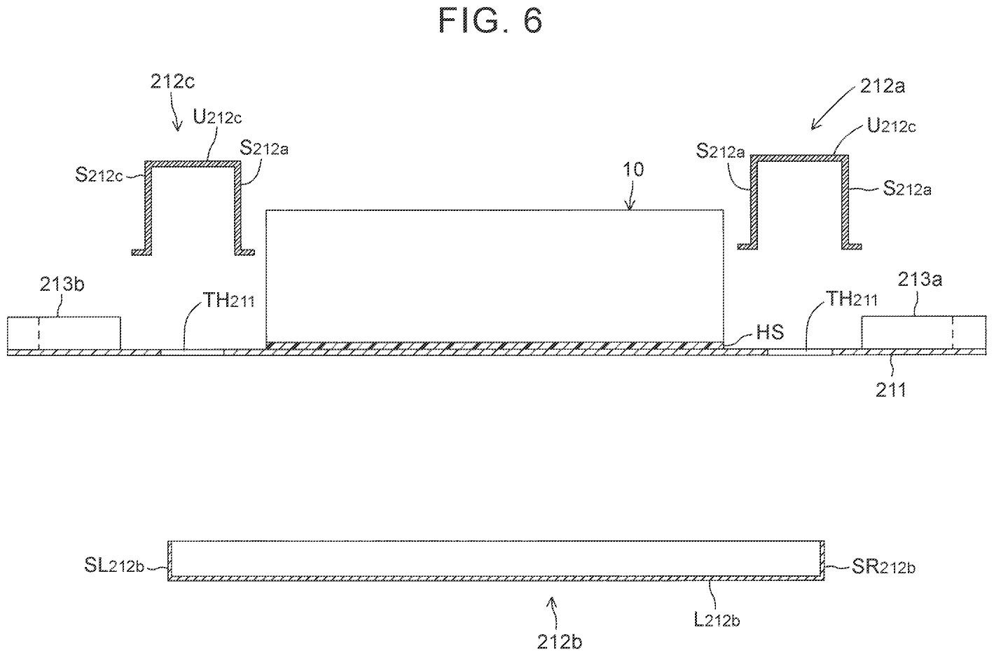

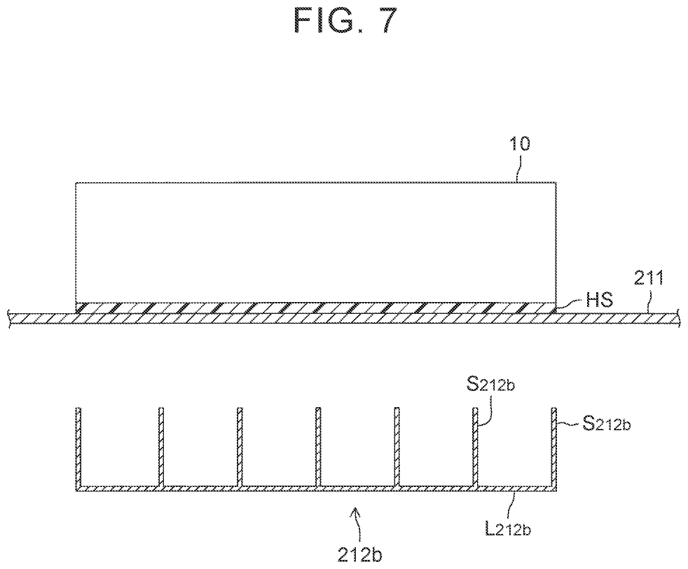

The base plate 211 is a rectangular plate-shaped member extending in the front-rear direction. The plate-thickness direction of the base plate 211 is along the up-down direction. The battery modules 10 are placed on an upper surface of the base plate 211. The battery modules 10 are placed such that the arrangement direction of the battery cells 11 constituting each of the battery modules 10 is along the right-left direction. The battery modules 10 are arranged at predetermined intervals in the front-rear direction. A sheet HS having a relatively high heat conductivity is inserted between the battery modules 10 and the base plate 211 (see FIGS. 6, 7). The battery modules 10 are fixed to the base plate 211 via a bracket (not illustrated).

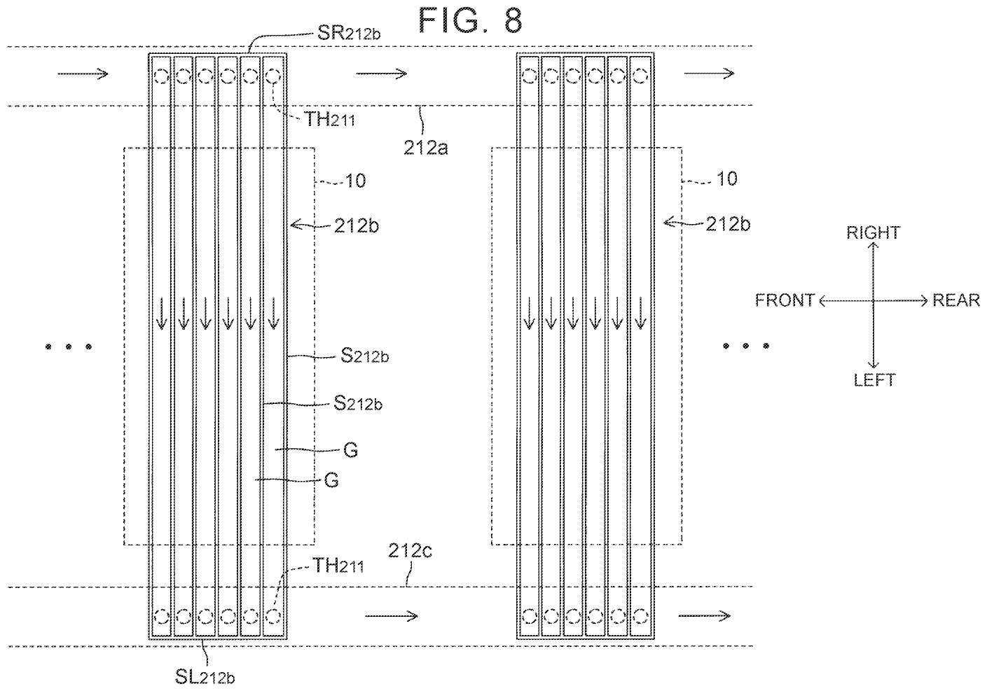

A plurality of round through-holes TH₂₁₁ is formed in a left part and a right part of the base plate 211 across the battery modules 10 (see FIGS. 3, 8). The through-holes TH₂₁₁ correspond to grooves G of second channels 212b (described later), respectively. The through-holes TH₂₁₁ have the same inside-diameter.

The heat exchanger 212 includes a first channel 212a, a plurality of second channels 212b, and a third channel 212c (see FIG. 3).

The first channel 212a is a groove-shaped member extending linearly in the front-rear direction. The first channel 212a is opened downward (see FIGS. 3, 6). That is, the first channel 212a includes an upper wall portion U₂₁₂ₐ having a band-plate shape and extending in the front-rear direction, and side wall portions S₂₁₂ₐ extending in the front-rear direction along right and left end parts of a lower surface of the upper wall portion U₂₁₂ₐ and perpendicular to the upper wall portion U₂₁₂ₐ. The wall-thickness direction of the upper wall portion U₂₁₂ₐ is along the up-down direction, and the wall-thickness direction of the side wall portions S₂₁₂ₐ is along the right-left direction. The first channel 212a is formed integrally by use of an extrusion molding method. Note that a rectangular plate material is joined to a rear end of the first channel 212a, so that the rear end of the first channel 212a is closed.

The first channel 212a is placed rightward from a space where the battery modules 10 are arranged, on the upper surface side of the base plate 211. The first channel 212a is placed such that a generally central part of the first channel 212a in its groove-width direction (the right-left direction) is placed above the through-holes TH₂₁₁, and respective bottom ends of the side wall portions S₂₁₂ₐ of the first channel 212a are joined (welded) to the upper surface of the base plate 211. That is, a tubular portion (a first tubular portion) constituted by the upper wall portion U₂₁₂ₐ and the side wall portions S₂₁₂ₐ of the first channel 212a and the base plate 211 is provided rightward from the battery modules 10.

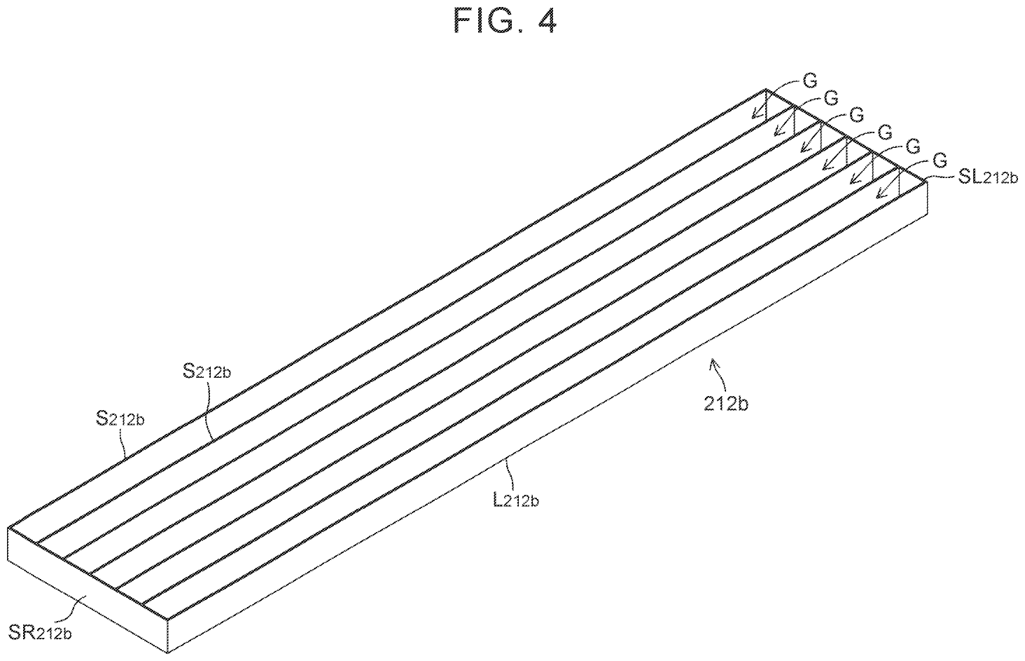

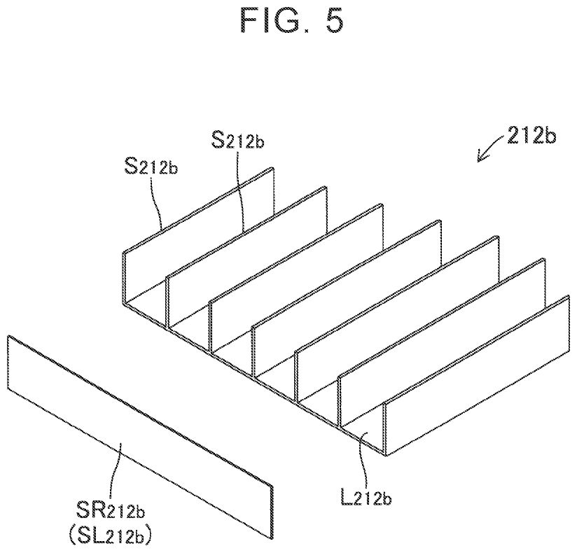

The second channels 212b correspond to the battery modules 10, respectively. The second channel 212b includes a plurality of grooves G extending linearly in the right-left direction (see FIG. 4). The grooves G are opened upward. That is, the second channel 212b includes a lower wall portion (bottom wall portion) L_{212b} having a band-plate shape and extending in the right-left direction, and a plurality of side wall portions (vertical wall portions) S_{212b} extending in the right-left direction on an upper surface of the lower wall portion L_{212b} and perpendicular to the lower wall portion L_{212b}. The wall-thickness direction of the lower wall portion L_{212b} is along the up-down direction, and the wall-thickness direction of the side wall portions S_{212b} is along the front-rear direction. That is, the side wall portions S_{212b} are placed at regular intervals in the front-rear direction. A part placed between two side wall portions S_{212b} adjacent to each other in the front-rear direction corresponds to the groove G. An overall length (a dimension in the right-left direction) of the second channel 212b is larger than an overall length (a dimension in the right-left direction) of the battery module 10. A width (a dimension in the front-rear direction) of the second channel 212b is equivalent to a dimension of the battery module 10 in the front-rear direction. The lower wall portion L_{212b} and the side wall portions S_{212b} of the second channel 212b are formed integrally by use of an extrusion molding method. Note that a side wall portion SR_{212b} and a side wall portion SL_{212b} each constituted by a rectangular plate material are joined to a right end and a left end of an extruded body, respectively (see FIG. 5). That is, the right end and the left end of the second channel 212b are closed.

The second channels 212b are placed on the lower surface side of the base plate 211 (see FIGS. 3, 6, 7). The second channels 212b are placed below the battery modules 10, respectively. Respective upper ends of the side wall portions S_{212b} and the side wall portions SR_{212b}, SL_{212b} of the second channel 212b are joined (welded) to the lower surface of the base plate 211. That is, a plurality of tubular portions (second tubular portions) each constituted by the lower wall portion L_{212b} and the side wall portions S_{212b} of the second channel 212b and the base plate 211 is provided below each of the battery modules 10 (on the lower side of the base plate 211). Note that respective positions of the through-holes TH₂₁₁, respective groove widths of the grooves G of the second channel 212b, and so on are set in advance so that right and left end parts of the grooves G of the second channel 212b communicate with the through-holes TH₂₁₁ formed rightward and leftward from the battery module 10.

The configuration of the third channel 212c is similar to the configuration of the first channel 212a. That is, the third channel 212c is a groove-shaped member extending linearly in the front-rear direction. The third channel 212c is opened downward. That is, the third channel 212c includes an upper wall portion U_{212c} having a band-plate shape and extending in the front-rear direction, and side wall portions S₂₁₂c extending in the front-rear direction along right and left end parts of the lower surface of the upper wall portion U_{212c} and perpendicular to the upper wall portion U_{212c}. The third channel 212c is formed integrally by use of an extrusion molding method. Note that a rectangular plate material is joined to a front end of the third channel 212c, so that the front end of the third channel 212c is closed.

The third channel 212c is placed on the upper surface side of the base plate 211 (see FIGS. 2A, 3). The third channel 212c is placed leftward from the space where the battery modules 10 are arranged. The third channel 212c is placed such that a generally central part of the third channel 212c in its groove-width direction is placed above the through-holes TH₂₁₁ (see FIG. 8), and respective upper ends of the side wall portions S_{212c} of the third channel 212c are joined (welded) to the lower surface of the base plate 211 (see FIGS. 6, 7). That is, a tubular portion (a third tubular portion) constituted by the upper wall portion U_{212c} and the side wall portions S_{212c} of the third channel 212c and the base plate 211 is provided leftward from the battery modules 10.

The frame 213 is joined to an outer peripheral edge of the upper surface of the base plate 211 and reinforces the base plate 211 (see FIG. 3). The frame 213 is constituted by a right frame 213a and a left frame 213b. The right frame 213a and the left frame 213b have symmetrical shapes in the right-left direction. The following describes the configuration of the right frame 213a, and the left frame 213b is not described herein.

The right frame 213a includes a main frame member F1 extending in the front-rear direction along a right edge part of the base plate 211, and a front frame member F2 and a rear frame member F3 extending slightly leftward from a front end and a rear end of the main frame member F1.

The cover portion 22 is a box-shaped member extending in the front-rear direction, and the cover portion 22 is opened downward (see FIG. 1). A bottom end of a side wall portion of the cover portion 22 is joined to an outer peripheral portion of the upper surface of the base portion 21. Note that a joined portion between the base portion 21 and the cover portion 22 is sealed so that water, dust, and so on do not enter the cover portion 22.

A circulation device (a compressor, a pump, or the like) (not illustrated) configured to circulate coolant as refrigerant to the heat exchanger 212 is connected to the heat exchanger 212. That is, a front end of the first channel 212a and a rear end of the third channel 212c are connected to an outlet and an inlet of the circulation device, respectively. Refrigerant discharged from the circulation device flows in the first channel 212a from the front end of the first channel 212a and flows therethrough rearward. (see FIG. 8). The refrigerant passes through the through-holes TH₂₁₁, flows (splits) into respective right end parts of the grooves Gin the second channels 212b, and flows leftward (to the third channel 212c side) from the right end parts of the grooves G. At this time, heat of the battery modules 10 is transmitted to the base plate 211, the side wall portions S_{212b}, and the lower wall portion L_{212b} via the sheet HS. Then, heat is exchanged between the refrigerant and the lower surface of the base plate 211, the side wall portions S_{212b}, and the lower wall portion L_{212b}. Then, the refrigerant passes through the through-holes TH₂₁₁ from the left end parts of the grooves G so as to flow in (join) the third channel 212c, and the refrigerant returns to the circulation device from the rear end of the third channel 212c. Note that the circulation device includes a heat exchanger (a radiator) (not illustrated). The heat exchanger (radiator) dissipates heat of the refrigerant to an external air.

As described above, in the battery device in the related art, the heat exchanger formed in a tubular shape is joined to the base plates in advance. In this case, abutment parts between the base plates and an upper surface of an upper wall portion among wall portions constituting a tubular portion as the heat exchanger have a large thermal resistance to heat from the battery modules.

On the other hand, the second channels 212b in the battery device 1 according to the present embodiment include the grooves G opened upward. Respective upper ends of the side wall portions S_{212b} and the side wall portions SR_{212b}, SL_{212b} of the second channels 212b are directly joined to the lower surface of the base plate 211. On that account, heat is directly exchanged between the lower surface of the base plate 211 and the refrigerant. Accordingly, with the above configuration, it is possible to set the heat exchange efficiency to be high in comparison with the battery device in the related art. Further, in the battery device in the related art, in a case where a sheet similar to the sheet HS is inserted between lower surfaces of the base plates and the upper surface of the upper wall portion of the tubular portion, a thickness dimension of the battery device (a dimension in the up-down direction) increases. However, in the battery device 1, it is not necessary to provide a sheet between the second channels 212b and the base plate 211. Accordingly, the battery device 1 can be reduced in thickness in comparison with the battery device in the related art.

Further, generally, in a case where a tubular member (a member including a hollow portion) such as the heat exchanger in the related art is manufactured by use of an extrusion molding method, it is difficult to downsize the member (it is difficult to reduce the hollow portion in thickness), and a manufacturing speed (an extrusion speed) is relatively slow. On the other hand, since the second channel 212b is opened upward, the downsizing (reduction in thickness) is relatively easily achieved, and the manufacturing speed (the extrusion speed) is relatively high. As a result, a low manufacturing cost is achieved.

Further, as described above, in the present embodiment, the refrigerant is split from the first channel 212a to the grooves G of the second channels 212b, and the refrigerant then joins in the third channel 212c. Accordingly, the first channel 212a and the third channel 212c are set to be thicker (larger in groove width and groove depth) than the grooves G of the second channels 212b. In a case where the first channel 212a and the third channel 212c thicker than the second channels 212b as such are placed on the lower side of the base plate 211 similarly to the second channels 212b, a dimension (a dimension in the up-down direction) of a part projecting downward from the base plate 211 increases. That is, it is difficult to reduce the battery device 1 in thickness. In view of this, in the battery device 1, the second channels 212b are placed on the lower side of the base plate 211, and the first channel 212a and the third channel 212c are placed on the upper side of the base plate 211. Hereby, the battery device 1 can be reduced in thickness.

Further, the present disclosure is not limited to the above embodiment, and various alterations can be made within a range that does not deviate from the object of the present disclosure.

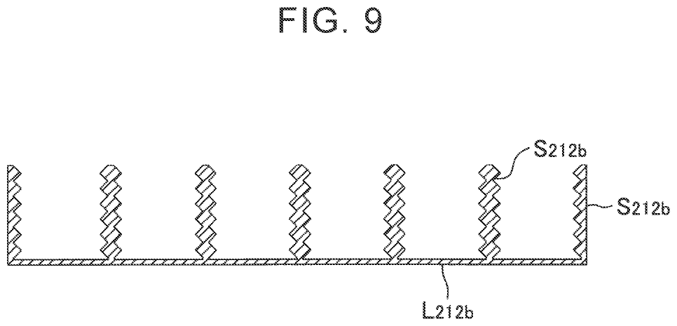

For example, the number of the side wall portions S_{212b} may be increased from the example illustrated in FIGS. 4, 8, and so on. Further, as illustrated in FIG. 9, the upper surface of the lower wall portion L_{212b}, a right surface and/or a left surface of the side wall portion S_{212b}, or the lower surface of the base plate 211 may be provided with recessed portions (or projection portions) extending in the right-left direction (a flow direction of the refrigerant). This can increase a surface area of the second channel 212b. That is, a contact area between the refrigerant and the second channel 212b increases. As a result, it is possible to improve the heat exchange efficiency.

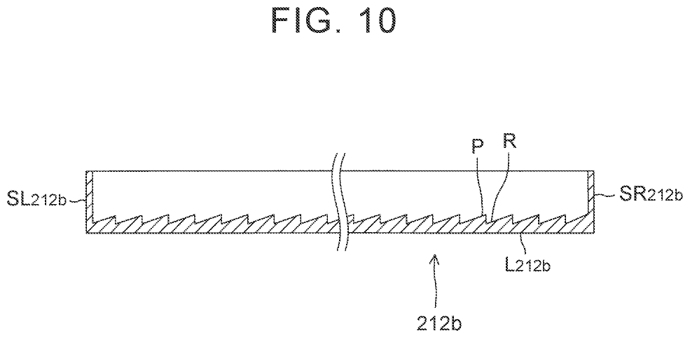

Further, as illustrated in FIG. 10, in the groove G (the lower wall portion L_{212b} or the side wall portion S_{212b}), a plurality of recessed portions R (projection portions P) may be placed at intervals in the right-left direction. This can intentionally cause turbulence (swirl) in the flow of the refrigerant in the groove G. Hereby, it is possible to further improve the heat transfer efficiency.

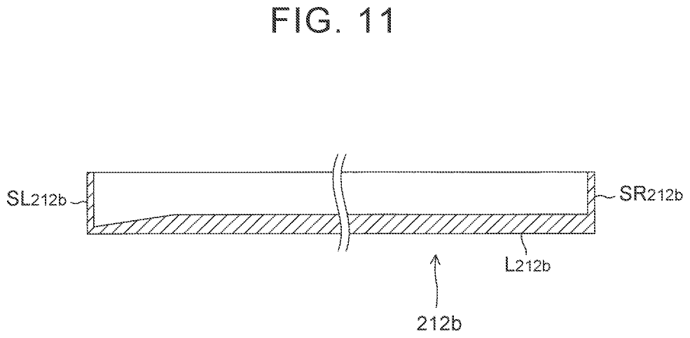

Further, as illustrated in FIG. 11, a sectional area (a groove depth or a groove width) of an end part of the groove G, the end part being on the first channel 212a side (that is, a part placed on an inlet side for the refrigerant and placed rightward from a space below the battery module 10), may be set to be larger than sectional areas of other parts of the groove G. With this configuration, in the groove G, a flow rate of the refrigerant on the downstream side from the inlet for the refrigerant (a part below the battery module 10) is higher than that in the inlet for the refrigerant. This can further improve the heat exchange efficiency. Note that the recesses and the projections in the examples of FIGS. 9, 10 can be formed by use of a laser beam machine, for example. Further, an additional component having recesses and projections may be attached to the groove G.

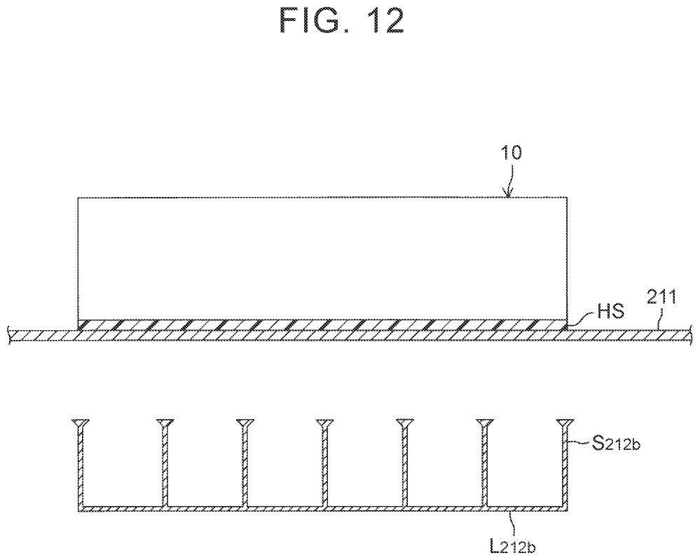

Further, as illustrated in FIG. 12, a plate thickness of the upper end of the side wall portion S_{212b} may be made larger than a plate thickness of a part, of the side wall portion S_{212b}, below the upper end. In this configuration, a joining area between the side wall portion S_{212b} and the base plate 211 is large, thereby making it possible to increase a joining strength therebetween.

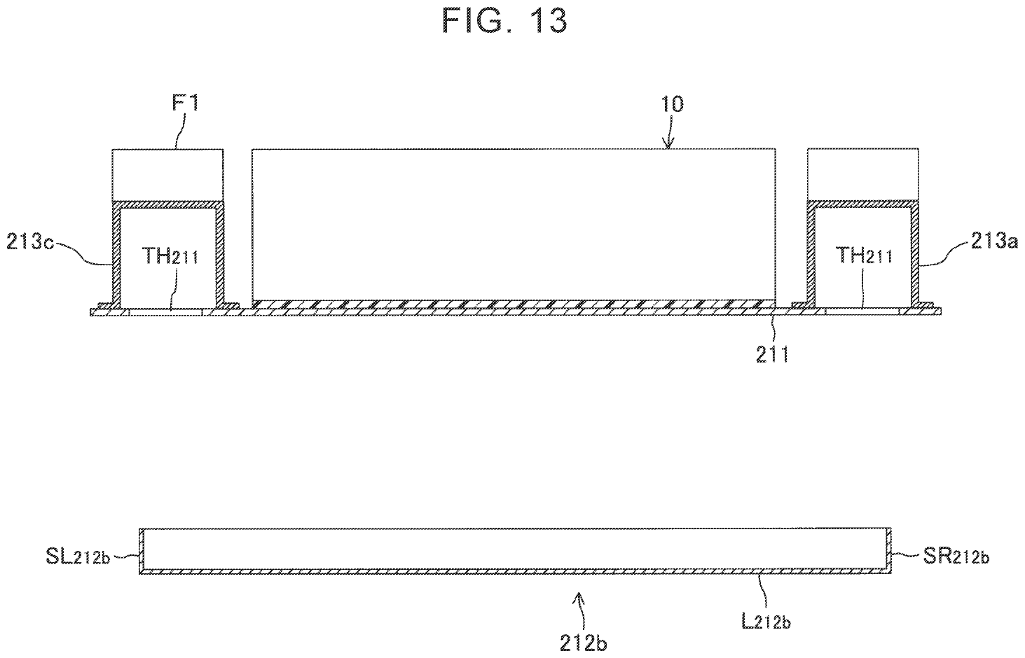

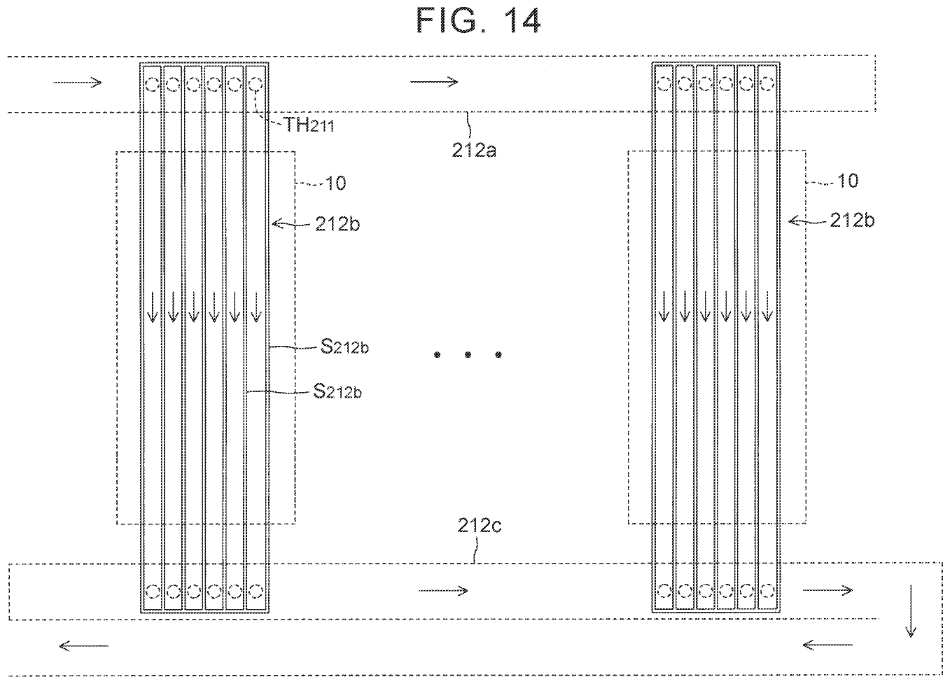

Further, as illustrated in FIG. 13, the first channel 212a (the third channel 212c) and the main frame member F1 may be integrated with each other. Further, as illustrated in FIG. 14, the third channel 212c may be folded back at its rear end part.

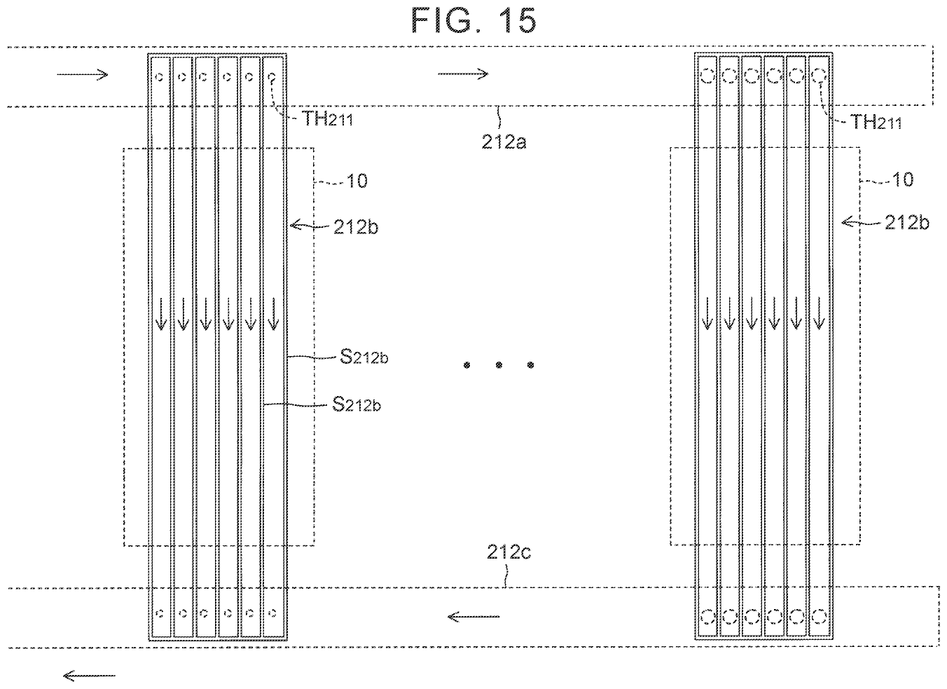

Further, in the above embodiment, the refrigerant is introduced into the heat exchanger 212 from the front end of the first channel 212a and discharged from the rear end of the third channel 212c. Instead of this, the refrigerant may be introduced into the heat exchanger 212 from the front end of the first channel 212a and discharged from the front end of the third channel 212c. In this case, the refrigerant might become hard to flow through the grooves G on the rear side (on a side distant from the inlet for the refrigerant) in comparison with the grooves G on the front side (that is, on a side closer to the inlet for the refrigerant). In view of this, in this case, the through-holes TH₂₁₁ may have different inside diameters depending on their positions. More specifically, the inside diameters of the through-holes TH₂₁₁ on the rear side may be set to be larger than the inside diameters of the through-holes TH₂₁₁ on the front side (see FIG. 15).

What is claimed is:

1. A battery device comprising:
a case; and
a plurality of battery cells stored in the case, the battery device being wherein:
the case includes a base portion on which the battery cells are placed, and a cover portion configured to cover the battery cells placed on the base portion;
the base portion includes
a base plate on which the battery cells are placed,
a bottom wall portion provided on a side of the base plate, the side being opposite to a surface on which the battery cells are placed, such that the bottom wall portion is provided at a position distanced from the base plate, and
a plurality of vertical wall portions having a band-plate shape, the vertical wall portions extending in a predetermined direction between the base plate and the bottom wall portion; and
opposite ends of the vertical wall portions in a width direction of the vertical wall portions are connected to the bottom wall portion and the base plate, respectively.

2. The battery device according to claim 1, wherein an end part of each of the vertical wall portions, the end part being on a side closer to the base plate, has a wall thickness larger than wall thicknesses of other parts of the each of the vertical wall portions.

3. The battery device according to claim 1, wherein recesses and projections are provided on an inner peripheral surface of a tubular portion defined by the base plate, the bottom wall portion, and the vertical wall portions.

4. The battery device according to claim 1, wherein a tubular portion defined by the base plate, the bottom wall portion, and the vertical wall portions is configured such that a sectional area of a first end side of the tubular portion in an extending direction of the tubular portion is larger than a sectional area of a second end side of the tubular portion.
